(19) United States
(12) Patent Application Publication
(10) Pub. No.: US 2012/0284100 A1
(43) Pub. Date: Nov. 8, 2012

(54) METHODS FOR FACILITATING ADVERTISING AND COMMERCIAL TRANSACTIONS

(76) Inventor: Adam Scott Goldberg, Columbus, OH (US)

(21) Appl. No.: 13/222,482

(22) Filed: Aug. 31, 2011

Related U.S. Application Data
(60) Provisional application No. 61/481,276, filed on May 2, 2011.

(51) Int. Cl. G06Q 30/00

(52) U.S. Cl. 705/14.19; 705/14.1; 705/14.35; 705/14.36; 705/14.31

(57) ABSTRACT

Methods of communicating for advertising and for facilitating commercial transactions between businesses and consumers. Said methods are enabled by a software application that allows a consumer to dispatch an offer request to a service provider, wherein the offer request specifies an amount of money that the consumer intends to spend on a particular product category and a geographic area in which the consumer intends to make a purchase. The service provider then communicates the offer request to a plurality of businesses that offer the specified product category and that are located within the specified geographic area. If the offer request satisfies certain criteria established by one or more of the businesses, those businesses will issue offers that advertise special deals and discounts to the consumer. Such offers are generated using a software application. The consumer can then accept and redeem any of the offers that the consumer finds attractive.

### BACKGROUND OF THE INVENTION

The present invention generally relates to the field of advertising, and relates more particularly to methods of communicating for allowing a consumer to solicit advertisements and offers from businesses.

Traditional advertising methods typically consist of a business communicating an offer or advertisement to a targeted population of consumers. For example, a business might run a televised product advertisement during the airing of a football game in order to reach a primarily male consumer population. Such communication generally occurs in a “one-way” fashion, with a business communicating its message to potential consumers without any direct solicitation or provocation from the target audience. This method of advertising is inherently inefficient, as only a very small fraction of the potential consumers who are exposed to such advertisements will be interested in, and will therefore ultimately purchase, the advertised goods or services. More sophisticated methods of advertising exist whereby consumers are provided with an opportunity to solicit future advertisements and special offers from a business, such as by providing the business with a home or email address to which advertisements can be sent. While this model allows consumers to initially communicate a broad level of interest to a business, it does not allow a business to identify an individual consumer's immediate need for a particular good or service. Thus, as with the television advertisement described above, the majority of the business's advertisements will be received by consumers who have no immediate interest in, and will therefore not purchase, the advertised item.

In addition to inefficiency and the inability to address the immediate needs of in-market consumers (i.e. consumers who have an immediate need for goods or services), there are a host of other problems that are commonly associated with traditional advertising methods that make such methods undesirable. A first problem, and a corollary to the general inefficiency of traditional advertising methods discussed above, is that most such methods do not guarantee a return on a business's investment. A business will generally be required to pay for advertising even if the advertising fails to deliver any business.

A second problem that is common to traditional advertising methods is that it is difficult, and in some cases impossible, for a business to measure the efficacy of such methods due to an inability to determine which consumers were exposed to a particular advertising method or if they were exposed to a business-initiated advertising method at all. This problem is somewhat less prevalent in the context of internet commerce, wherein so-called “click-through” traffic that enters business's website via a hyperlinked advertisement (e.g. advertisements posted on a third party website or contained in an email) can be measured using well-known methods. However, since most small businesses complete transactions offline at a physical place of business, such businesses will generally still lack the ability to determine whether a customer was motivated to initiate a transaction by a particular advertisement, even if the customer was exposed to an advertisement online.

A third problem that is common to traditional advertising methods is that such methods tend to be very expensive, and in many cases are prohibitively so. Conventional advertising methods that employ media such as paper coupons, internet search engines, email, radio, local and national television, billboards, print media, and social media can cost many thousands, and in some cases millions, of dollars. These types of advertising methods are therefore out of reach for many businesses, and particularly small businesses that maintain little or no funds for advertising.

A fourth problem that is common to traditional advertising methods is that businesses that engage in such methods subject themselves to the risk of overexposure. That is, since conventional advertisements are generally unsolicited by consumers, the vast majority of such advertisements, whether they be conveyed physically, by way of television or radio, or online, are unwanted by the consumers who receive them. Repeated, unsolicited advertisements can become annoying and even aggravating to a consumer, and over time the consumer may come to associate that annoyance and aggravation with the advertised business. Thus, instead of drawing consumers to the business as intended, the advertisement may actually push consumers away from the business.

A fifth problem that is common to some traditional advertising methods is that they are bad for the environment. The mass production of printed advertising media, such as coupons, flyers, handbills, periodical ads, and billboards, necessitates huge quantities of paper and, therefore, the destruction of trees and woodlands. Moreover, discarded printed media produces enormous amounts of waste, most of which is stored in the ever-growing landfills of the world. Such large scale consumption and disposal is unsustainable in the long term.

A sixth problem that is common to traditional advertising methods is that such methods do not allow consumers to leverage their freedom of choice to negotiate for better deals when deciding which local businesses to patronize. That is, conventional advertising methods do not provide a means by which a consumer can solicit competing offers from a plurality of businesses when the consumer is ready to make a purchase.

A seventh problem that is common to most traditional advertising methods is that such methods do not provide a means by which frequent customers of a business can be recognized for their loyalty to that business. This is particularly true for small businesses that do not have the resources to maintain customer databases or track purchases. Identifying customers that are “regulars” and providing them with special benefits can encourage such customers to maintain their loyalty and can encourage new customers to establish themselves as regulars. Conversely, if a customer feels that he or she is spending a great deal of money at a business and is not being recognized, that customer might stray to a competing business that the customer believes will show greater appreciation for his or her business.

In view of the foregoing, it would be advantageous to provide an advertising method that effectively and efficiently targets in-market consumers. It would further be advantageous to provide such an advertising method that facilitates convenient tracking of the efficacy of a particular advertisement. It would further be advantageous to provide such an advertising method that is affordable for small business owners. It would further be advantageous to provide such an advertising method that does not subject a business to the risk of overexposure. It would further be advantageous to provide such an advertising method that does not deplete natural resources and that does not create waste. It would further be advantageous to provide such an advertising method that allows consumers to leverage their freedom of choice among businesses to negotiate better deals. It would further be advantageous to provide such an advertising method that facilitates the identification of repeat customers.

### BRIEF SUMMARY OF THE INVENTION

In accordance with the present invention, there are provided methods for enabling solicited advertising and for facilitating commercial transactions between consumers and businesses. Such advertising and transactions are preferably managed and moderated by a service provider with whom the consumers and businesses register as members. The issuance and execution of advertisements and transactions are preferably enabled by software applications that the service provider furnishes to its member consumers and businesses.

A transaction is generally initiated by a consumer using a designated software application to generate and a dispatch an offer request to a service provider, wherein the offer request specifies a category of products (i.e. goods or services) that the consumer intends to purchase, a dollar amount that the consumer intends to spend on the products, and a geographical area in which the consumer intends to purchase the products. The consumer may specify additional details in the offer request, such as a time period during which the consumer wishes to make a purchase or a time at which the consumer wishes to receive a service (e.g. a dinner reservation or a hair appointment). The service provider then communicates the offer request to its member businesses that offer the specified category of products and that are located within the specified geographic area.

Upon receiving an offer request, a business will evaluate the request to determine whether the business wants to issue an offer to the requesting consumer. Such a determination is made based on certain criteria maintained by the business. For example, a business may choose to issue offers only in cases where an incoming offer request specifies an intended spending amount that is greater than a minimum value. In the case of a service-oriented business, the determination might be made based on the availability of reservation or appointment times at the businesses. If the business's offer request criteria are satisfied, the business will create an offer and send it to the consumer. Offers may contain special deals, discounts, or information intended to entice the consumer to visit the business and purchase the business's goods.

The evaluation of offer requests and the issuance of offers by a business is preferably a wholly automated process facilitated by a designated software application that is configured by the business. That is, the business can establish certain parameters within the software application that direct the application to issue particular, predetermined offers in response to offer requests exhibiting certain, specified criteria. Alternatively, a designated individual at a business can manually review incoming offer requests and issue offers when appropriate.

Upon receiving an offer from a business a consumer can choose to accept the offer, such as by indicating such acceptance in the consumer's designated software application. The consumer will then be presented with an offer coupon that specifies the details of the offer. The consumer can then print the offer coupon or can store the coupon on a mobile electronic device such as a smart phone. If the consumer wishes to redeem the offer, the consumer visits the business that issued the offer, satisfies the conditions specified in the offer (e.g. spending a particular amount of money on a particular type of product), and presents the offer coupon. The business then honors the offer by providing whatever special deal or discount is promised in the terms of the offer. If a business fails to honor a valid offer, the consumer can initiate a transaction dispute with the service provider who will then review the transaction. After a transaction is complete, the consumer can use the designated software application to post a review of the transaction that is viewable by other consumers who are members of the service provider's network.

The service provider preferably tracks the commercial activity of its member consumers, including, but not limited to activity such as the frequency with which consumers visit businesses within the service provider's network, the average amount a consumer spends per transaction at each business, and the total amount that a consumer has spent at each business. The service provider preferably provides this information to its member businesses to enable the businesses to identify their best customers. The businesses can thereby reward their best customers with special deals and discounts that incentivize the customers to maintain their loyalty.

### BRIEF DESCRIPTION OF THE SEVERAL VIEWS OF THE DRAWINGS

FIG. 1 is a flow chart illustrating an overview of a transaction facilitated by the methods of the present invention.

FIG. 2a is a schematic illustration of a consumer dispatching an offer request.

FIG. 2b is a schematic illustration of a plurality of businesses issuing offers in response to a consumer's offer request.

FIG. 2c is a schematic illustration of a plurality of businesses issuing offers in response to a consumer's offer request, including an additional “instant offer” relative to the offers shown in FIG. 2b.

FIG. 3a is a schematic illustration of a consumer dispatching an offer request.

FIG. 3b is a schematic illustration of a plurality of businesses issuing offers in response to a consumer's offer request.

FIG. 4a is a schematic illustration of an embodiment of the consumer interface of the present invention.

FIG. 4b is a schematic illustration of the consumer interface shown in FIG. 4a with the location drop down menu expanded.

FIG. 4c is a schematic illustration of the consumer interface shown in FIG. 4a with the activity category drop down menu expanded.

FIG. 4d is a schematic illustration of the consumer interface shown in FIG. 4a with the activity sub-category drop down menu expanded.

FIG. 4e is a schematic illustration of the consumer interface shown in FIG. 4a with the spend amount drop down menu expanded.

FIG. 5 is a schematic illustration of an embodiment of the business interface of the present invention.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose.

### DETAILED DESCRIPTION OF THE INVENTION

The present invention includes methods for allowing a consumer to notify businesses of the consumer's immediate need or desire to purchase goods or services, and to thereby solicit special advertisements or offers from the notified businesses. The term “consumer” shall be defined herein as any person who might potentially purchase goods or services. The term “immediate need or desire” shall be defined herein as a present need or desire that will preferably be satisfied within the foreseeable future, such as on the same day or on a scheduled, future date. The term “goods” shall be defined herein as any items normally sold in conventional retail stores or over the Internet, including, but not limited to, apparel, consumer electronics, sporting goods, appliances, home decor, furniture, tools, books, musical recordings, films, etc. The term “services” shall be defined herein to include any services that are normally offered to the general consuming public, such as dining, lodging, entertainment, hair and beauty, health and fitness, medical, dental, vision, pet care, automotive repair and maintenance, house cleaning, etc. Both goods and services can be grouped under the more general term “products.”

The methods of the invention are preferably implemented by computer software applications that are installed on fixed or mobile electronic computing devices on which the applications are executed. Such electronic devices include, but are not limited to, smart phones, personal data assistants (PDAs), tablet computers, laptop computers, desktop computers, servers, and computer kiosks. Most preferably, the consumer-oriented aspects of the inventive methods (described in detail below) are enabled by a mobile application, commonly referred to as an “app,” that is installed on a consumer's smart phone, such as an iPhone, an Android enabled phone, or a Blackberry. Alternatively, it is contemplated that the software applications that enable the methods of the present invention can be maintained and executed remotely, such as through the use of so-called “cloud computing” platforms. It will be understood by persons having ordinary skill in the art that the methods of the present invention can be used in other, non-software applications, and that the software applications can be modified and enhanced in such ways as to change their functionality while retaining the essential elements of the invention. The particular software language and software code used to implement the methods embodied by the software applications described herein are not critical to the invention and will therefore not be described in detail.

Generally, the methods of the present invention will involve interactions between three types of parties: 1) consumers; 2) businesses that provide goods and services to consumers; and 3) service providers that provide the aforementioned software applications to participating consumers and businesses and who facilitate and moderate commercial interactions between consumers and businesses (preferably for a fee). For example, businesses that wish to engage in the methods of the present invention in a particular geographical area will pay a fee to a service provider to be included in a commercial network that operates in accordance with the methods described below. The service provider is then responsible for administering the commercial network for the benefit of the member businesses and for member consumers who register with the service provider and who subsequently purchase goods and services from the member businesses.

Various communications and interactions between consumers, businesses, and service providers will be described herein. Such communications and interactions are facilitated by conventional network access means that may include wired and wireless Internet connections, voice and data telecommunications connections, in-store systems, in-locale systems, and kiosk systems. Although one form of communication or interaction is specified, a person of ordinary skill will understand how to use other forms as a substitute. Thus, when one form is described, the reader should note that others are contemplated even though they are not described.

Transaction Overview

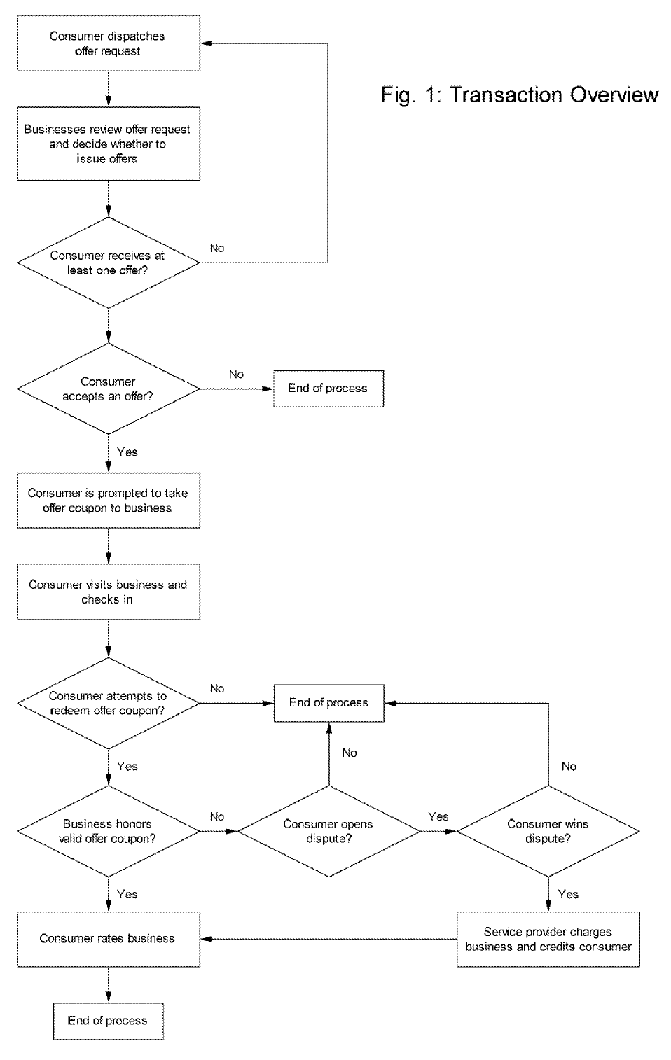

A flowchart illustrating the progression of a typical commercial transaction facilitated by the methods of the present invention is shown in FIG. 1. The flowchart provides a broad overview of the functionality offered by the inventive methods. A more detailed explanation of the various aspects of the inventive methods, including variations, alternatives, and additional features, will be provided below.

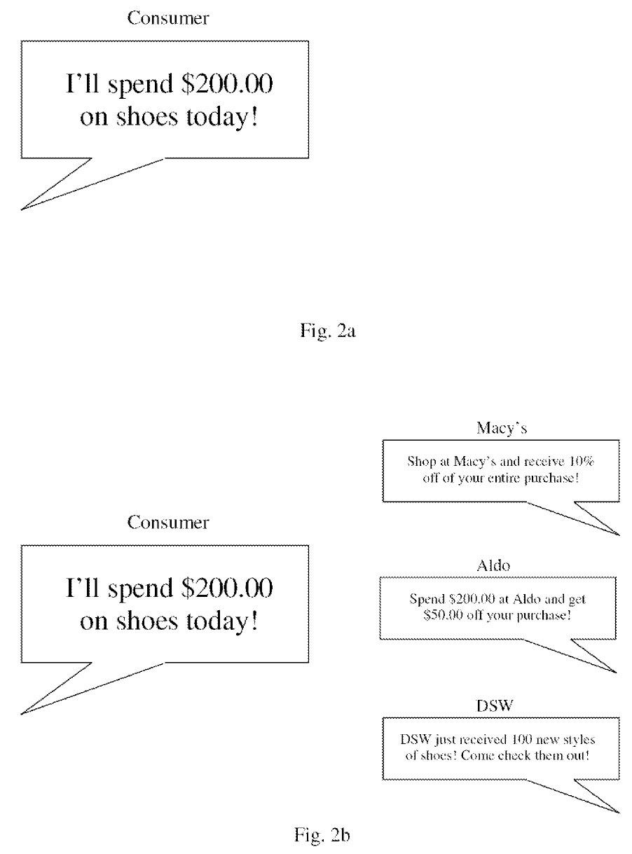

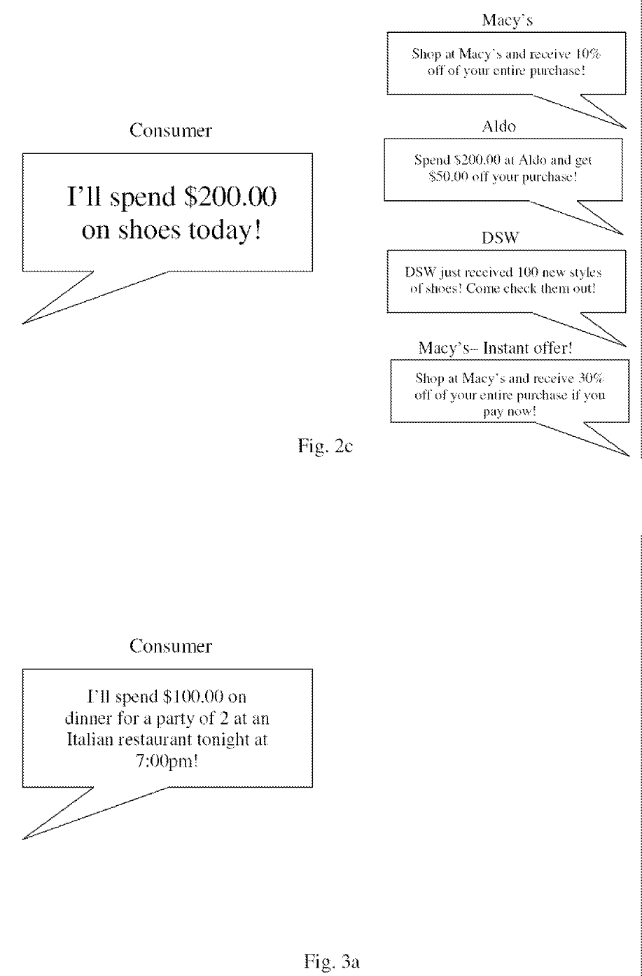

Referring to FIG. 1, a consumer first uses a designated software application, such as a designated mobile shopping application that is installed on his or her smart phone, or a designated web-based shopping application that is maintained on a service provider's website, to create and dispatch an “offer request” to local businesses. An offer request is a non-binding announcement that states the consumer's intent to purchase a particular dollar amount worth of goods or services at a particular time or during a particular time period. For example, referring to FIG. 2a, a consumer may dispatch an offer request announcing her intent to spend $200.00 on a pair of shoes today. In another example illustrated in FIG. 3a, a consumer might dispatch an offer request announcing his intent to dine at an Italian restaurant at 7:00 pm tonight with a party of 2 and a budget of $100.00.

The consumer's offer request is electronically communicated to local businesses, and preferably fee-paying local member businesses (i.e. businesses that are part of a local business network administered by a service provider), that provide the type of good or service that is specified in the offer request. “Local” is preferably defined to mean within a predetermined distance (designated by the user or by the service provider) from the current location of the consumer, as may be determined through the use of geo-location means such as the global positioning satellite (GPS) capability of a consumer's smart phone.

Alternatively, “local” can be defined to mean within the same city or region as the consumer, or within a remote city or region that is designated by the consumer that the consumer wishes to travel to in the future. It is further contemplated that the term “local businesses” can include remotely-located businesses that offer goods and/or services that can be purchased online and delivered locally.

Referring back to FIG. 1, upon receiving the consumer's offer request, the recipient businesses each review the request to determine whether or not they wish to respond by issuing a corresponding offer or advertisement that is intended to entice the consumer to visit their business. Businesses that wish to issue such a response will then utilize a designated software application, such as may be maintained as a web application (e.g. on a service provider's website) or installed on a business's desktop or laptop computer or mobile electronic device, to create an offer or advertisement that is preferably tailored to address the consumer's particular offer request. Alternatively, a business may employ a generic or “canned” offer or advertisement that is not specifically tailored to the incoming offer request. For example, referring to FIG. 2b, three different retailers responded to the offer request that was dispatched by the consumer in FIG. 2a. Macy's offered a 20% discount on the consumer's entire purchase; Aldo offered a $50.00 discount on a purchase of $200.00 or more; and DSW notified the consumer that they have just received 100 new styles of shoes. In this example, the offers from Macy's and Aldo are specifically-tailored offers and the offer from DSW is a canned offer. Referring to FIG. 3b, two different Italian restaurants responded to the offer request that was dispatched by the consumer in FIG. 3a. Tony's Italian Ristorante offered two free appetizers if the consumer spends $100.00 on food and beverages; and Trattoria Roma offered 15% off of the bill if the consumer spends $100.00 on food only (not including alcoholic beverages). Both of these offers are tailored offers.

Referring again to FIG. 1, the businesses' offers are electronically communicated back to the consumer's smart phone and are presented to the consumer within the designated shopping application. The offers are preferably delivered to the consumer within seconds of the consumer's submission of his or her offer request. This is accomplished through the automated generation and dispatch of the businesses' offers (described in greater detail below). Alternatively, it is contemplated that the review of an offer request and the preparation and sending of an offer can be performed manually, such as by a designated individual at the business. In such a case, the delivery of an offer can be delayed for as much time as it takes for the designated individual to review a consumer's offer request, manually prepare a corresponding tailored or canned offer, and send such offer back to the consumer.

Manual responses to offer requests will generally be more prevalent in the context of service-oriented businesses, such as restaurants, hair salons, doctors offices, law offices, health spas, auto mechanics, and massage salons, wherein an individual at the business might have to consult an appointment book or reservation book in order to determine whether the consumer can be accommodated at or around a requested time. It is contemplated that the application software that embodies the methods of the present invention can be operatively interfaced with a business's reservation, appointment, Point of Sale, or other back or front office computer system(s), such as through the implementation of an application program interface (API), so that the availability of a particular reservation or appointment time can be verified automatically. Such automation would make manual review and offer preparation unnecessary even for service-oriented businesses.

After receiving an offer, a consumer is preferably given a predetermined amount of time to accept the offer. The particular amount of time given is preferably determined by the business that sends the offer or by the service provider. Alternatively, it is contemplated that the amount of time can be a standard value that is measured from the time the consumer dispatches his or her offer request. If the consumer does not select an offer in the designated time period, he or she will lose the ability to take advantage of that offer unless the offer is solicited again through the submission of a subsequent offer request. For example, the offer will no longer appear in the designated shopping application on the consumer's smart phone. Additionally, the consumer is preferably prohibited from submitting another offer request using the same query for a period of time, such as until the end of the day, although this is not critical. The “same query” refers to another offer request that specifies the same category (e.g. restaurant) and sub-category (e.g. Italian) of good or service (described in greater detail below). Prohibiting multiple offer requests in this manner prevents a consumer from attempting to “game the system,” such as by submitting multiple offers in an effort to solicit a better offer. An example of “gaming the system” would be the shoe customer described above repeatedly submitting her offer request with incrementally lower announced spending amounts for the purpose of determining the minimum spending amount she would have to state in order to solicit the “$50 off your purchase” offer from Aldo or the “10% off your purchase” offer from Macy's.

If a particular offer is allowed to expire (i.e. if a consumer does not accept an offer during the allotted time period) the consumer is preferably allowed to submit an offer request using the same query on the same day if the consumer increases the dollar amount that they are willing to spend by a predetermined amount. For example, if neither of the offers shown in FIG. 3b are accepted by the consumer during the allotted time period, the consumer will be allowed to submit a similar offer request for Italian dining on the same day only if the consumer increases the amount he is willing to spend on dinner to at least $120.00. The minimum amount by which the offer request must be increased relative to the initial offer request is preferably determined by the offering business. A consumer is preferably also allowed to re-submit an offer request if he did not receive any offers in response to his previous submission.

In some cases, a business might receive an offer request that announces a spending amount that is marginally below what the business requires to provide a discount or special deal. Nevertheless, the business might want to inform the customer that if he were to spend slightly more than his stated offer request amount he would be eligible to take advantage of a special offer. Referring to the offer request in FIG. 3b, for example, a third Italian restaurant might respond to the consumer's offer request for an Italian dinner by issuing an offer for a free bottle of wine if the consumer spends a minimum of $125.00 (as opposed to the consumer's stated spending amount of $100.00) on food. The consumer can then decide whether he would be willing to spend more money on dinner to take advantage of the offer.

Referring to the next step in the transaction process shown in FIG. 1, the consumer then decides whether he or she would like to select one or more of the presented offers. If the consumer selects an offer, such as by clicking or tapping on a graphical representation of the offer on the consumer's computer or smart phone, the shopping application will preferably generate an offer coupon that the consumer will be instructed to print (if the consumer is using a web application) or that will be stored on the consumer's smart phone or other such mobile device (if the consumer is using a mobile device). The shopping application will then instruct the consumer to bring to the offering business the printed coupon or the smart phone on which the coupon is stored. The printed or electronically-stored offer coupon will preferably include an expiration date (or time) after which the offer is no longer valid, as well as an identification code, such as an alphanumeric code or a bar code, that is uniquely associated with the offer coupon and that is also communicated to the offering business for its records.

Next, the consumer visits the business whose offer the consumer selected and spends the amount of money that was agreed upon. In order to take advantage of the offer, the consumer might also be required to meet certain other conditions that are stated in the offer, such as having a party of a particular size when visiting a restaurant (e.g. maximum party of 2) or purchasing specified goods at a retailer (e.g. a particular brand of shoes). At or prior to the point of purchase, the consumer presents the business with the offer coupon corresponding to the offer they wish to redeem. “Redeeming an offer” shall be defined herein as the act of converting a business's promise (i.e. an offer) into something of monetary value for a consumer (e.g. a discount or a special deal). After verifying that the offer coupon is valid, such as by checking the expiration date on the coupon and checking the identification number on the coupon against the business's record of issued offer coupons, the business honors the offer by providing the consumer with whatever discount or special deal was promised in the accepted offer.

It is contemplated that a business can honor an offer even in a case where a consumer fails to spend an agreed upon amount of money on the business's goods or services. Referring to the example in FIG. 2b, if the consumer selects the offer from Aldo and subsequently spends only $190.00 on shoes instead of $200.00 as stated in the offer, Aldo may still decide to honor the offer and give the consumer $50.00 off of her purchase. The decision of whether or not the business will honor an offer in such a circumstance is preferably left to the discretion of the business. Alternatively, it is contemplated that member businesses can be required to honor offers in cases of marginally-lower-than-agreed-upon purchases as a condition of membership with their service provider. It is further contemplated that the minimum acceptable purchase amount that would cause a business to honor an offer, either by choice or by condition, can be calculated as a standard deviation below the agreed-upon purchase amount, but this is not critical and many other methods of determining such a minimum purchase amount can alternatively be used.

If a business fails to honor a valid, unexpired offer coupon that is presented by a consumer, the consumer is preferably provided with an option to dispute the transaction. A transaction dispute is preferably effectuated by the consumer sending (e.g. by email or by standard mail) a copy of the receipt from the transaction, along with a copy of the offer coupon that is at issue, to their service provider. More preferably, a dispute is effectuated by a consumer selecting a “dispute” option in the designated shopping application on the consumer's electronic device (or in a web application), at which point the application prompts the consumer to electronically attach or upload a scanned copy of his transaction receipt, which is then sent to the service provider. Alternatively, the consumer can take a picture of the receipt with his or her mobile electronic device and send the picture to the service provider via SMS, MMS, email, or another form of electronic communication.

Upon receiving notice of the dispute, the service provider then compares the receipt to the offer that is at issue. If the conditions in the offer were met by the consumer, as evidenced by the receipt, the service provider will preferably charge the offering business the amount due the consumer under the terms of the offer (i.e. the difference between what the consumer actually paid and what the consumer would have paid if the offer had been honored). The service provider can additionally charge the business a service fee and/or a penalty fee. The amount due the consumer will then be credited to the consumer, such as in the form of a check that is mailed to the consumer or by electronically crediting a bank or credit card account belonging to the consumer if such account information is maintained by the service provider. Furthermore, the service provider will preferably maintain a record of the total number of disputes that a business has “lost” (i.e. disputes that demonstrate that the business failed to honor a valid offer). The disputes records of all businesses within a service provider's network are preferably presented to the consumers who utilize the network. Businesses that accumulate too many lost disputes can be removed from the service provider's network or placed on suspension from the network for a period of time.

In addition to the types of offers described above, which can be identified as “standard offers,” it is contemplated that a business can also issue a different type of offer called an “instant offer.” An instant offer is an offer that requires a consumer to pay an agreed-upon purchase amount at the time the offer is selected as opposed to when the consumer visits the business. For example, the consumer can authorize payment from a credit card that is kept on-file by the service provider, or the consumer can provide her credit card, Paypal, or other payment information directly to the offering business. Since the consumer must commit to an instant offer by paying a purchase amount upfront, and since a business has the benefit of being guaranteed immediate revenue through the acceptance of an instant offer, such offers will typically advertise discounts and special deals that are more attractive than those contained in standard offers. It is contemplated that a business can issue both a standard offer and an instant offer in response to a single offer request. Referring to FIG. 2c, for example, Macy's has issued an instant offer for 30% off a purchase of $200.00 if the consumer pays now, in addition to its standard offer of 10% off of a purchase of $200.00 if the consumer pays in-store. If a consumer takes advantage of an instant offer her resulting offer coupon will include a credit for the appropriate dollar amount, and the instant offer discount will preferably also be applied to any additional amount the consumer spends in-store. Thus, if the consumer in the FIG. 2c example selects the instant offer from Macy's, she will pay $140.00 for an offer coupon that provides a $200.00 merchandise credit. If the consumer then visits Macy's and ultimately wishes to purchase a total of $250.00 worth of shoes, she will preferably receive 30% off of the additional $50.00 of her purchase (above the agreed-upon $200.00 stated in the instant offer), resulting in a total payment of $175.00 for $250.00 worth of shoes.

Another type of offer that a business can issue is a “limited time offer.”“Limited time offers” differ from standard offers and instant offers in that they are unsolicited by consumers, and they are advertised in limited quantities for a predetermined amount of time that is specified by a business. For example, a limited time offer might state that a restaurant is offering 20 buy-one-get-one-free dinner entrée deals until 9:00 pm. The first 20 consumers who accept the offer before 9:00 pm will be eligible to receive the deal. When a limited time offer is displayed to a consumer it preferably contains a counter that is updated in real time that informs the consumer of how many offers remain, thereby increasing consumers' sense of urgency as the availability of the offer decreases.

To effectuate a limited time offer, a business will specify a demographic of consumers it wishes to target (in a manner that will described in greater detail below), a maximum number of available offers, and a time at which the limited time offer will expire. The limited time offer will then be pushed (sent electronically) to the appropriate consumers in the service provider's network. Limited time offers can be useful for periods during which business is uncharacteristically slow, such as on a weekend night when a restaurant has fewer than expected reservations. As with instant offers, it is preferred that consumers be required to pay for limited time offers at the time of acceptance. Service providers preferably limit the number of limited time offers a business can send in a given amount of time (e.g. during the course of a day) and consumers are preferably provided with the ability to opt out of limited time offers if they do not wish to receive unsolicited advertisements from businesses.

Referring again to FIG. 1, when a consumer activates her mobile shopping application on her smart phone (i.e. if the consumer is using a smart phone) upon visiting a business to redeem an offer, the application preferably prompts the consumer to “check in” at the business. “Checking in” is the act of electronically logging the consumers presence at a business. Checking in is preferably accomplished by pressing a “check in” button within the shopping application. The application then utilizes the smart phone's GPS functionality to record the consumer's geo-location to prove that the consumer is at the offering business. It is contemplated that the check-in process can be facilitated by third-party location services, including, but not limited to FourSquare, Gowalla, Facebook, and Google. In most cases, third party location services can provide the name of a business that a consumer checks into, as opposed to providing only longitude and latitude information. The service provider collects check-in information and shares it with the business, thereby allowing the business to track customer activity and identify repeat or “regular” customers (described in greater detail below). Preferably, consumers will be prompted to check in at an offering business that they visit regardless of whether or not the consumer ultimately redeems the offer that drew them to the business.

Generally, a consumer may check into a business after they have left the physical location of the business, but in such a case the consumer's visit will not be verifiable unless the consumer redeemed the subject offer at the business. Alternatively, a consumer can be required to check into a business before they are allowed to access and redeem an offer. A consumer who is not using a smart phone or other mobile device will be prompted to engage in the above-described check in process upon subsequently logging into the designated web application or software application on her personal computing device. Again, the consumer's visit will generally not be verifiable unless the consumer redeemed the subject offer at the business.

Consumers are preferably encouraged to check into businesses even if they are not visiting the business to redeem an offer, and even if the business is not part of the service provider's network. This allows a service provider to build a record of the number of consumers who visit a non-member business, and to use such information to entice the business to join the network. For example, a service provider can communicate to a non-member business that over 100 consumers who are members of the network visited the business within the last 30 days, and that 75 of those consumers indicated that they would like the business to be part of the network. To further entice the business to join, the service provider can offer the business direct access to the member customers who visited the business if the business chooses to join the network.

Next, in addition to prompting a consumer to check in at a business, the shopping application will preferably also prompt the consumer to indicate whether they: a) redeemed an accepted offer; b) did not use the offer; or c) have a dispute. The consumer will preferably be blocked from accessing other parts of the application unless and until they make such an indication. Alternatively, a consumer can be allowed access to the full application but will be sent periodic reminders to make such an indication until they do so. If the consumer indicates that they redeemed the offer, and if the consumer does not have a pending dispute with the offering business, the consumer will be provided with an opportunity to rate the business. For example, in one embodiment of the invention, the application will present the consumer with a numerical score scale ranging from 1 to 5, with 1 being the “absolute worst” score, 2 being a “not good” score, 3 being a “neutral” score, 4 being a “good” score, and 5 being the “absolute best” score. The consumer is also allowed to type a few sentences describing their experience with the business. Consumer reviews are viewable by other consumers in the service provider's network, thereby providing consumers with valuable, advance information regarding network businesses and incentivizing network businesses to maintain good customer relations. Those of ordinary skill in the art will recognize that there are many other types of rating and review systems that can be substituted for the one described above without departing from the present invention.

A consumer who has a pending dispute with a business will only be able to rate the business after the dispute has been settled and it has been determined that the business lost the dispute (i.e. the business did not honor a valid offer coupon presented by the consumer). If a business wins a dispute, the disputing consumer will not be allowed to rate the business. This system feature protects businesses from unwarranted negative reviews that could otherwise be posted by angry, at-fault, or unscrupulous consumers.

Consumer Interface

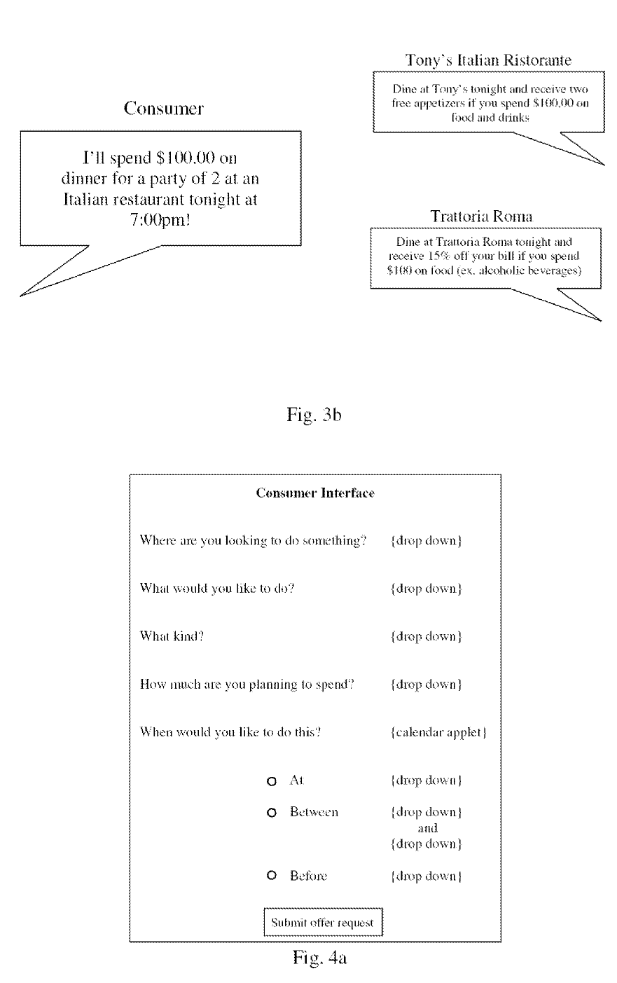

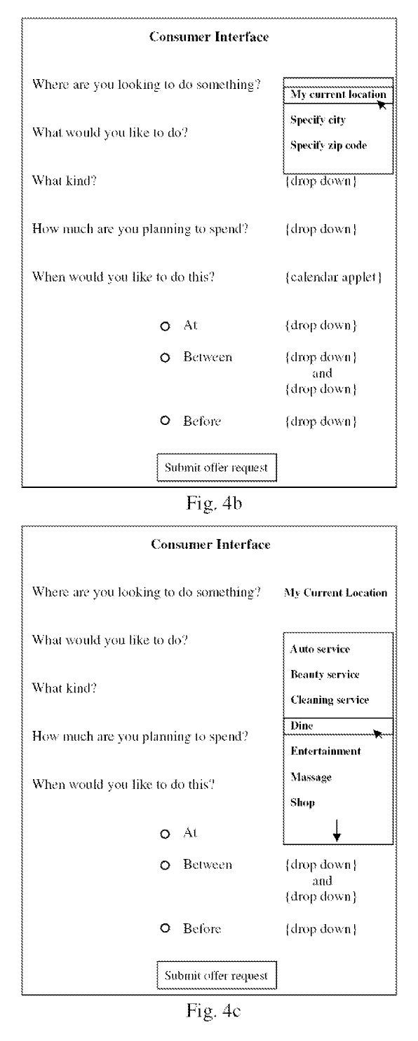

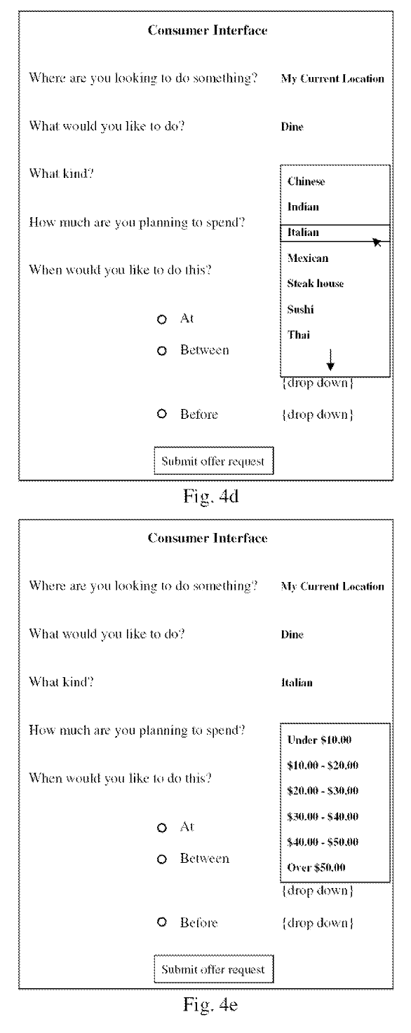

Referring to FIGS. 4a-4e, an exemplary embodiment of a consumer interface for the above described shopping application is shown. The consumer interface is provided in the consumer version of the shopping application, which is distributed to the member consumers of a service provider, and a business interface (described below) is provided in a separate, business version of the shopping application that is distributed to the member businesses of a service provider. While the exemplary consumer interface illustrated in FIGS. 4a-4e bears a particular appearance and has a particular configuration, it will be understood by those of ordinary skill in the art that many different variations of the consumer interface, having different appearances and different configurations, can be employed without departing from the present invention.

Referring to FIG. 4a, the consumer interface presents a consumer with a first question that prompts the consumer to indicate where she would like to engage in an activity. For example, the question can be stated as “Where are you looking to do something?”, “Where will you be?”, or some variation thereof. A standard drop down menu or text field that will be familiar to those of ordinary skill in the art is provided next to, or in close proximity to, the text of the first question for allowing the consumer to specify a location. Referring to FIG. 4b, the drop down menu includes location options labeled “My current location,” “Specify city,” and “Specify zip code.” If the consumer selects the “My current location” option, the consumer application will utilize the GPS capability or the IP address of the consumer's electronic device to determine the consumer's location. If the consumer selects the “Specify city” option, a text field will appear below the drop down menu for allowing the consumer to manually enter the name of a city and a state where she would like to engage in an activity. Similarly, if the consumer selects the “Specify zip code” option, a text field will appear below the drop down menu for allowing the consumer to manually enter the zip code of a location where she would like to engage in an activity.

Next, the consumer interface presents the consumer with a second question that prompts the consumer to indicate a primary category of activity she would like to engage in. For example, the question can be stated as “What are you looking to do?”, “What would you like to do?”, or some variation thereof. A drop down is provided next to, or in close proximity to, the text of the second question for allowing the consumer to specify a primary category of activity. Referring to FIG. 4c, the drop down menu includes primary category options such as “Auto service,” “Beauty service,” “Cleaning service,” “Dine,” “Entertainment,” “Massage,” “Shop,” etc. The particular options provided in the primary category menu will depend on the location entered by the consumer in response to the first question and on the types of businesses that are members of a corresponding service provider's network at that location. For example, if a health club is a member of the service provider's network in the proximity of the location specified by the consumer in her answer to the first question, one of the options provided to the consumer will be “Health and fitness” or some variation thereof. Conversely, if there are no cleaning service providers in the network at the specified location then a “Cleaning service” option will not appear in the menu.

Next, the consumer interface presents the consumer with a third question that prompts the consumer to indicate a sub-category of activity she would like to engage in. For example, the question can be stated as “What type?”, “What kind?”, or some variation thereof. Again, a drop down menu is provided next to, or in close proximity to, the text of the third question for allowing the consumer to specify a sub-category of activity. The options provided in the sub-category menu will depend on the primary category of activity that was specified by the consumer in response to the second question and on the types of businesses that are members of the of the particular service provider's network in the proximity of the specified location. For example, referring to FIG. 4b, the consumer has specified “My current location” in response to the first question and “Dine” as the primary category of activity in response to the second question. Referring to FIG. 4d, the sub-category menu therefore provides options that allow the consumer to specify what type of restaurant among those available in her local service provider's network she would like to dine at, such as “Chinese,” “Indian,” “Italian,” “Mexican,” “Steak house,” “Sushi,” “That”, etc. Alternatively, if the consumer had specified a primary category of “Beauty service,” for example, the sub-category menu would provide options such as “Hair,” “Makeup,” “Nails,” “Skin,” etc.

Next, the consumer interface presents the consumer with a fourth question that prompts the consumer to indicate the amount of money she is planning to spend on the activity that was specified in questions two and three. For example, the question can be stated as “How much are you planning to spend?” or some variation thereof. Again, a drop down menu is provided next to, or in close proximity to, the text of the fourth question for allowing the consumer to specify a dollar amount. Referring to FIG. 4e, the menu will preferably provide a series of monetary ranges that are appropriate for the type of activity that was selected by the consumer. Since the consumer previously selected “Dine” and “Italian” in response to questions two and three, the menu will offer monetary ranges that are appropriate for dining at Italian restaurants of various price ranges within the specified area. If a consumer selects an activity that is typically more expensive, such as auto maintenance, the provided monetary ranges will generally be higher, and for typically less expensive activities the ranges will be lower. There is preferably also provided an option labeled “I don't know” or some variation thereof that can be selected in situations in which the consumer may not be familiar with how much a particular service, such as auto repair, might cost. However, businesses will generally be less likely to respond to offer requests that do not specify a dollar amount since a business may not be able to tailor an offer to such an offer request that guarantees an adequate level of revenue.

Finally, the consumer interface presents the consumer with a fifth question that prompts the consumer to indicate when she would like to engage in the activity specified in her answers to questions two and three. For example, the question can be stated as “When will you be doing this?”, “When would you like to do this?”, or some variation thereof. Referring to FIG. 4a, a text field or a conventional, clickable calendar applet is preferably provided next to, or in close proximity to the text of the question for allowing the consumer to specify a date. A series of time options are then presented that allow the consumer to specify a specific time or time range when she would like to engage in the specified activity. The options are preferably labeled “At,” “Between,” and “Before.” If the consumer selects either the “At” or “Before” option, a drop down menu will appear that presents a list of specific times (e.g. “12:00 pm,” “12:30 pm,” “1:00 pm” . . . ) that the consumer can select to indicate that she would like to engage in the specified activity at or before the indicated time, respectively. If the consumer selects the “Between” option, two drop down menus will appear that each present a list of specific times that the consumer can select to indicate the she would like to engage in the specified activity between a first earliest time and a second latest time. It is contemplated that the ability to specify a time or a time range for an activity may only be provided if the consumer has selected an appointment or reservation based activity, such as dining or massage, wherein such information is important for allowing businesses that provide such services to determine availability.

In addition to those described above, it is contemplated that many other questions and information entry fields can be provided in the consumer interface for allowing consumers to provide additional information about the activity he or she wishes to engage in.

It is further contemplated that the presentation of such questions and information entry fields can be made to depend on the type of activity specified. For example, if a consumer specifies that he wishes to dine, the consumer can be asked to enter the size of his party.

In the exemplary embodiment of the consumer interface shown in FIGS. 4a-4e, all of the questions and their respective drop down menus are simultaneously presented to the consumer when the consumer interface is first displayed. An alternative embodiment of the consumer interface is contemplated where only the first question and its drop down menu are presented when the consumer interface is first displayed, and each subsequent question and its respective drop down menu is displayed only after the consumer specifies an answer for the immediately preceding question.

Business Interface

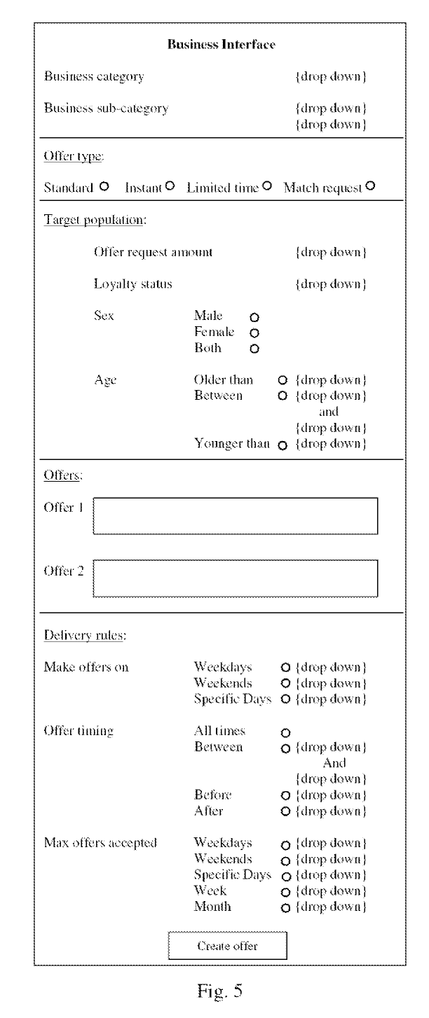

Referring to FIG. 5, an exemplary embodiment of a business interface for the above described shopping application is shown. As previously stated, the business interface is provided in the business version of the shopping application. Businesses that are members of a service provider's network use the business interface to create offers by specifying the attributes of the consumer population they wish to target, their business category and subcategory, the frequency with which their offers are sent as well as the days and times the offers should and should not be sent, and the maximum number of a particular offer to send. Generally, a business will launch the business interface by indicating within the business application that they wish to create a new offer, such as by clicking a button labeled “Create new offer” or some variation thereof.

While the exemplary business interface illustrated in FIG. 5 bears a particular appearance and has a particular configuration, it will be understood by those of ordinary skill in the art that many different variations of the business interface, having different appearances and different configurations, can be employed without departing from the present invention.

The business interface presents a business with a first pair of labeled drop down menus that prompt the business to specify the business's category and sub-category. There are preferably several drop down menus provided next to the sub-category label for allowing a business to specify several sub-categories, if applicable. For example, a business that specifies “Restaurant” as its business category could specify both “Japanese” and “Sushi” as sub-categories. After entering the category and sub-category information for the first time such information will be permanently maintained by the service provider in association with the business and the business will preferably not be prompted to enter the information again. Alternatively, such information can be requested and recorded by the service provider when a business initially registers its membership with the service provider, in which case the business would not be prompted to enter category and sub-category information by the business interface.

Next, the business interface presents the business with a series of clickable options that prompt the business to indicate whether it wishes to create a standard offer (described above), an instant offer (described above), a limited time offer (described above), or a match request offer (described below under “Match Request”). The type of offer that is selected will dictate the types of subsequent options that are presented to the business, as will be described below.

Next, the business interface presents the business with a series of labeled, clickable options and associated drop down menus (where appropriate) that prompt the business to enter specific parameters that, if met, will cause an automatic offer to be sent in response to a consumer's offer request (in the case of standard and instant offers), or that will define the consumer population to which the offer will be sent (in the case of limited time offers). Such parameters include, but are not limited to, an offer request amount (in the case of standard and instant offers; stated as a minimum dollar amount or as a monetary range), consumer information such as the age, sex, location, and hobbies of the consumer, and the consumer's loyalty status with regard to the business (e.g. new, repeat, or regular customer). It is contemplated that that consumer's personal information, while not required, can be collected by a service provider upon the consumer's registration as a network member in order to facilitate offers that are better tailored for the consumer. For example, a man would not want to receive advertisements from a hair salon that only provides services for women.

Next, the business interface provides the business with a plurality of text fields wherein the business can enter one or more offers that will be dispatched in response to consumers. That is, the business can specify a plurality of different offers that can be sent immediately (in the case of limited time offers) or at a future time in response to offer requests that satisfy the above-described offer parameters that are set by the business (in the case of standard offers and instant offers). The business can thereby provide multiple offers to a single target consumer population. Such offers can be sent simultaneously or can be rotated by the service provider. The service provider can then provide the business with analytics regarding which offers are accepted most often, which offers are redeemed most often, which offers produce the most revenue, etc. A business can log into its business interface and modify the contents of an offer at any time.

Next, if the business is creating a standard offer or an instant offer, the business interface presents the business with a plurality of clickable options and associated drop-down menus (where appropriate) that prompt the business to specify delivery rules that dictate when and how many of the specified offers can be sent. The business can specify that the offers be sent on weekdays only, weekends only, on both weekdays and on weekends, and/or on a specific weekday or weekend day. The business can also specify that the offer(s) be sent anytime, only between specified times on the specified day(s), only before a specified time on the specified day(s), or after a specified time on the specified day(s). The business can further specify a maximum number of times that offer can be sent on weekdays, weekends, specific weekdays or weekend days, over the course of a week, and over the course of a month. Once it is determined that the maximum number of issued offers has been reached for a specified time period, the offer(s) will be suspended until the beginning of a new time period (e.g. the beginning of a new month), at which time the offer(s) will resume until the maximum is reached again. In addition to being able to set a maximum that will halt the sending of a particular offer, a business can log into its business interface and pause an offer or (set of offers) at any time for an indefinite period.

Alternatively, if the business is creating a limited time offer, the business interface presents the business with a plurality of clickable options and associated drop-down menus (where appropriate) that prompt the business to specify an expiration time for the offer and a maximum number of offers that are available. Once the expiration time for the offer is reached, or the number of consumers that have accepted the limited time offer reaches the maximum number or offers set by the business, the offer will be suspended.

In addition to the offer system described above, wherein offers are either sent without solicitation by a consumer (in the case of limited time offers) or are sent automatically in response to offer requests from consumers (in the case of standard offers or instant offers), a business can review and respond to the offer requests of consumers manually. That is, a designated individual at the business can use the business application to view incoming offer requests in real time and can send offers to requesting consumers on an individual basis. In such cases, the business application allows the designated individual at the business to enter a new offer to send to a particular consumer (in a similar manner to the above-described entry of an offer). Alternatively or additionally, the business application preferably allows the designated individual to select a previously entered automatic or “canned” offer to send to the consumer. If the designated individual wishes to review and respond to offer requests manually, he or she will preferably first suspend active automatic offers.

Match Requests

Upon receiving an offer, regardless of whether the offer is solicited or not, a consumer will preferably be presented with the option of issuing a “match request”. A match request allows a consumer to redirect an offer from a first business to a specified second business (which may or may not have also issued an offer to the consumer) along with a request that the second business match or beat the offer from the first business. Match requests will typically be employed in situations where a consumer prefers an offer issued by a first business but prefers the goods, services, or convenience offered by a second business. For example, the consumer in FIG. 2b might choose to send a match request to Trattoria Roma requesting that the restaurant match or beat the offer presented by Tony's Italian Ristorante if the consumer prefers the food at Trattoria Roma. The consumer interface preferably provides a “Match Request” option that will automatically redirect a specified offer to a specified business.

A business can set up automatic offer replies to match requests in the same manner that standard offers are constructed (described above), with the exception that the business must specify the “Match request offer” option (described above) when creating the offer. Such offers will only be sent in response to incoming match requests from consumers. It is further contemplated that a business can specify that it wishes to only match offers that are issued by certain, specified business. It is further contemplated that a business can exclusively offer to match or beat the offers of the other businesses without creating any offers of its own.

Loyalty Programs

Each business in a service provider's network preferably maintains a loyalty program that is enabled by analytics furnished by the service provider. For example, a service provider can inform a business regarding which consumers check into the business most frequently, which consumers accept and redeem the business's offers most frequently, which consumers spend the most money at the business, and which consumers rate the business most favorably. Consumers are preferably identified to a business using code names or numbers, and any personal information that would enable a business to learn the actual identity of a consumer is hidden from the business unless a consumer gives a service provider permission to provide such information.

Using the consumer analytics from the service provider a business can employ its own criteria to determine its best customers, also referred to as “regulars.” Businesses are preferably able to send unsolicited offers directly to their regular customers. Such offers will typically include special deals and special discounts that are intended to reward regulars for their loyalty and to incentivize regulars to maintain their loyalty. A business may also send a special deal or a targeted message to a regular who has not visited the business for a longer-than-average period of time (i.e. based on the regular's previous frequency) in an effort to bring that regular back into the business. It is further contemplated that a business can contact regulars on a periodic basis to keep them informed of new goods or services offered by the business.

Targeted Offer Requests

It is contemplated that consumers who have redeemed an offer at a business at least once can be provided with an option within the consumer interface to send that business a “targeted offer request.” A targeted offer request is an offer request that is dispatched only to a specified business that is designated by the consumer, as opposed to being dispatched to all of the businesses in a service provider's network that are located within a defined geographical area and that can satisfy the offer request. For example, a repeat customer of a restaurant might send a targeted offer request to that restaurant announcing that the customer wishes to eat dinner at the restaurant that night and is willing to spend $200.00 if the restaurant provides a deal or a discount.

Consumer analytics (described above) provided by the service provider enable a business to determine the relative value of consumers who issue targeted offer requests. It is contemplated that the service provider can even assign a numerical score or value to a consumer with regard to a particular business, and such a score or value can be used as an additional parameter if a business chooses to set up automated responses to targeted offer requests in the business interface (see above). A business can thereby choose to accommodate targeted offer requests that are sent by higher value customers (e.g. regulars) and not to accommodate such requests sent by lower value customers. Alternatively, a business can provide higher value customers who make targeted offer requests with better deals than lower value customers. A business may be more willing to accommodate targeted offer requests that are sent during periods of slow business, or, for particularly valuable customers, the business may accommodate targeted offer requests even during very busy periods to demonstrate the business's appreciation for the customer's loyalty.

Unsolicited Offers

In addition to issuing offers in response to offer requests from consumers, businesses are preferably also able to send unsolicited offers to consumers who are willing to receive them. Businesses are preferably limited with regard to the number of unsolicited offers they can send in a given period of time (e.g. over the course of a day) and businesses may be required to pay an additional fee to the service provider for the ability to send unsolicited offers. Additionally, a business can be limited to sending unsolicited offers only to previous customers of the business. As with limited time offers, consumers can specify to their service provider whether or not they wish to receive unsolicited offers. It is contemplated that consumers who do not wish to receive unsolicited offers can be required to pay an additional membership fee to the service provider, whereas consumers who agree to receive unsolicited offers are allowed to maintain their memberships with the service provider for free. Unsolicited offers are preferably accepted and redeemed in the same manner as standard offers (described above).

Shared Offers

It is contemplated that, in some cases, a consumer can share an offer sent by a business with another consumer within a service provider's network to whom the offer was not directly sent by the business. Such an offer is referred to as a “shared offer.” A shared offer is preferably effectuated by a business specifying that a particular outgoing offer can be shared, such as by selecting an appropriate option when creating the offer. Upon receiving the offer, the consumer will then have the option to share the offer with another consumer, such as by clicking a button labeled “Share” and specifying the user name or email address of one or more other consumers on the network. The offer will then be sent to the specified consumer(s), who will then be able to select and redeem the offer in the manner described above. A consumer who receives a shared offer will preferably also have the option of sharing the offer with additional consumers of his or her choosing. This ability to share offers expands the reach of businesses' advertising efforts and adds a social element to the inventive method.

Peer-to-Peer Offer Requests

An alternative embodiment of the present invention is contemplated wherein consumers are provided with the ability to issue offer requests that target other consumers instead of businesses. Such offer requests are referred to as a “peer-to-peer offer requests.” A peer-to-peer offer request issued by a consumer is made viewable by other consumers on the applicable service provider's network, any of whom can respond to the request by issuing an offer. For example, a consumer could issue a peer-to-peer offer request stating his or her intent to purchase a used XYZ brand bicycle for X amount of dollars. Another consumer on the network who owns such a bicycle can then respond with an offer to sell the bicycle to the requesting consumer. In another example, a consumer could issue a peer-to-peer offer request stating his desire to have his grass mown for Y amount of dollars. Another consumer who lives nearby and who is willing to mow grass for the stated amount could then respond appropriately.

Offer Management System

Service providers preferably limit the quantity of offers that can be sent to a consumer in response to the consumer's offer request. Preferably, the service provider will only present a selected quantity of the best offers from businesses to a requesting consumer, and will rank those offers in order of best to worst. This saves the consumer time and provides the consumer with a better overall experience on the service provider's network by allowing the consumer to avoid situations in which he or she would have to sift through large quantities of offers in order to find the best ones.

A service provider uses an algorithm to determine the quality of offers that are sent in response to a consumer's offer request. Offers that are accepted and redeemed more frequently will be ranked higher than those that are accepted and redeemed less frequently. Offers that are not accepted frequently enough will preferably be removed from the network. A service provider may also inspect the content of an offer to determine the total value provided by the offer (e.g. in terms of the total discount advertised in an offer), and may additionally or alternatively use such value information to rank offers that are displayed to requesting consumers.

The above-described offer management system incentivizes businesses to issue high quality offers, thereby enhancing the overall experience for consumers who use the network. Over time, a service provider can refine its algorithm for assessing offer quality based on previously successful and unsuccessful models in order to enhance the network further.

Directory

A service provider preferably provides a searchable, electronic directory of its member businesses to its member consumers. The directory is preferably organized according to the categories and sub-categories of the member businesses. Consumers are preferably notified of the entry of new businesses, new categories, and new sub-categories into the directory, as well as of the addition of new network features, on a periodic basis (e.g. weekly or monthly).

Revenue Models

It is contemplated that a service provider can implement a variety of different revenue models for generating revenue from its member businesses. Such revenue models include, but are not limited to:
A Pay per Offer Sent (PPOS) model, wherein a business only pays a service provider when the business issues an offer. The payment can be a flat fee or can be calculated as a percentage of the value of the offer.
A Pay per Accepted Offer (PPAO) model, wherein a business only pays a service provider when an offer the business has issued is accepted. Again, the payment can be a flat fee or can be calculated as a percentage of the value of the accepted offer.
A Pay per Redeemed Offer (PPRO) model, wherein a business only pays a service provider when an offer the business has issued is redeemed. Again, the payment can be a flat fee or can be calculated as a percentage of the value of the redeemed offer.

It is contemplated that the above-described revenue models can be employed independently or simultaneously in any combination or permutation. It is further contemplated that any of the above-described models can be implemented in a tiered fashion, wherein the amount that a business is charged per OS, AO, or RO decreases as the total number of the business's OS, AO, and/or RO increases over a given time period (e.g. day, week, or month). It will be appreciated by those of ordinary skill in the art that there are many other revenue models that can be employed by a service provider without departing from the present invention.

Alternative Communication Media

Although Internet and cellular network communication means have been disclosed above as the preferred means for facilitating communications between consumers, businesses, and service providers for effectuating the methods of the present invention, it is contemplated that any other communication means can alternatively or additionally be employed. For example, it is contemplated that a consumer can issue an offer request by speaking their request into a voice recognition system, such as while driving a vehicle, and that corresponding offers can subsequently be delivered to the consumer in an audio format via the consumer's radio. It is further contemplated that requested offers can be delivered to a consumer in an audio/visual format on a consumer's television. Still further, it is contemplated that automobiles can be equipped with devices that communicate the purchasing intent of automobile occupants to billboards that dynamically change their content to address the occupants' intent. Many other forms of communication, including those that facilitate each of consumer-to-business, business-to-consumer, and consumer-to-consumer communication, are contemplated but are not described herein

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. A method of communicating for facilitating commercial activity between a consumer and at least one business, the method comprising:
a) the consumer using an electronic device to communicate an offer request to said at least one business, the offer request stating a dollar amount that the consumer intends to spend on one or more products offered by said at least one business; and
b) said at least one business using an electronic device to communicate an offer to the consumer if the offer request meets certain criteria.

2. The method in accordance with claim 1, wherein the offer request further states a time frame during which the consumer prefers to purchase said at least one business's products.

3. The method in accordance with claim 1, wherein the offer request further states a time at which the consumer prefers to purchase said at least one business's products.

4. The method in accordance with claim 1, wherein the offer request further states a geographical area in which the consumer prefers to purchase said at least one business's products.

5. The method in accordance with claim 1, wherein the offer comprises an advertisement of said at least one business's products.

6. The method in accordance with claim 1, wherein the offer comprises a special deal on said at least one business's products.

7. The method in accordance with claim 1, wherein the offer comprises a discount on said at least one business's products.

8. The method in accordance with claim 1, further comprising the consumer accepting the offer.

9. The method in accordance with claim 8, further comprising the consumer checking in at the business.

10. The method in accordance with claim 8, further comprising the consumer redeeming the accepted offer.

11. The method in accordance with claim 10, further comprising the consumer presenting an offer coupon to said at least one business upon redeeming the offer.

12. The method in accordance with claim 10, further comprising:
a) the consumer disputing the transaction if said at least one business refuses to honor terms of the offer; and
b) said at least one business refunding an amount to the consumer if the consumer wins the dispute.

13. The method in accordance with claim 10, further comprising the consumer rating his experience with said at least one business.

14. A method of communicating for facilitating commercial activity between a consumer and at least one business, the method comprising:
a) the consumer using an electronic device to communicate an offer request to said at least one business, the offer request stating a dollar amount that the consumer intends to spend on one or more products offered by said at least one business;
b) said at least one business using an electronic device to communicate an offer to the consumer if the offer request meets certain criteria;
c) the consumer accepting the offer; and
d) the consumer redeeming the accepted offer.

15. The method in accordance with claim 14, wherein the offer request further states a time frame during which the consumer prefers to purchase said at least one business's products.

16. The method in accordance with claim 14, wherein the offer request further states a time at which the consumer prefers to purchase said at least one business's products.

17. The method in accordance with claim 14, wherein the offer request further states a geographical area in which the consumer prefers to purchase said at least one business's products.

18. The method in accordance with claim 14, wherein the offer comprises an advertisement of said at least one business's products.

19. The method in accordance with claim 14, wherein the offer comprises a special deal on said at least one business's products.

20. The method in accordance with claim 14 wherein the offer comprises a discount on said at least one business's products.

21. The method in accordance with claim 14, further comprising the consumer presenting an offer coupon to said at least one business upon redeeming the offer.

22. The method in accordance with claim 14, further comprising the consumer checking in at the business.

23. The method in accordance with claim 14, further comprising:
a) the consumer disputing the transaction if said at least one business refuses to honor terms of the offer; and
b) said at least one business refunding an amount to the consumer if the consumer wins the dispute.

24. The method in accordance with claim 14, further comprising the consumer rating his experience with said at least one business.

25. A method of communicating for facilitating commercial activity between a consumer and at least one business, the method comprising:
a) the consumer using an electronic device to dispatch an offer request to a service provider, the offer request stating a category of product that the consumer intends to purchase;
b) the service provider using an electronic device to communicate the offer request to said at least one business that offers the category of product stated in the offer request; and
c) said at least one business using an electronic device to issue an offer to the consumer if the offer request meets certain criteria.

26. The method in accordance with claim 25, wherein the offer request further states a dollar amount that the consumer intends to spend on products offered by said at least one business.

27. The method in accordance with claim 25, wherein the offer request further states a geographical area in which the consumer prefers to purchase the products offered by said at least one business.

28. The method in accordance with claim 25, wherein the offer request further states a time frame during which the consumer prefers to purchase said at least one business's products.

29. The method in accordance with claim 25, wherein the offer request further states a time at which the consumer prefers to purchase said at least one business's products.

30. The method in accordance with claim 25, wherein the offer comprises an advertisement of said at least one business's products.

31. The method in accordance with claim 25, wherein the offer comprises a special deal on said at least one business's products.

32. The method in accordance with claim 25, wherein the offer comprises a discount on said at least one business's products.

33. The method in accordance with claim 25, further comprising the consumer accepting the offer.

34. The method in accordance with claim 33, further comprising the consumer checking in at the business.

35. The method in accordance with claim 33, further comprising the consumer redeeming the accepted offer.

36. The method in accordance with claim 35, further comprising the consumer presenting an offer coupon to said at least one business upon redeeming the offer.

37. The method in accordance with claim 35, further comprising:
a) the consumer disputing the transaction if said at least one business refuses to honor terms of the offer;
b) the service provider charging said at least one business an amount due the customer under the terms of the offer if the customer wins the dispute; and
c) the service provider crediting the consumer the amount due the consumer under the terms of the offer if the consumer wins the dispute.

38. The method in accordance with claim 35, further comprising the consumer rating his experience with the business.

39. The method in accordance with claim 35, further comprising the service provider providing said at least one business with analytics regarding the consumer.

40. The method in accordance with claim 39, wherein the analytics comprise a frequency with which the consumer visits said at least one business.

41. The method in accordance with claim 39, wherein the analytics comprise a total amount that the consumer has spent at said at least one business.

42. The method in accordance with claim 39, wherein the analytics comprise an average amount that the consumer spends at said at least one business per transaction.

43. The method in accordance with claim 39, further comprising said at least one business using the analytics to determine whether the consumer is a regular.

44. The method in accordance with claim 43, further comprising said at least one business providing the consumer with special deals if the consumer is a regular.

45. A method of communicating for facilitating commercial activity between a consumer and at least one business, the method comprising:
a) the consumer using an electronic device to dispatch an offer request to a service provider, the offer request stating a category of product that the consumer intends to purchase, a dollar amount that the consumer intends to spend, and a geographical area in which the consumer prefers to purchase products offered by said at least one business;
b) the service provider using an electronic device to communicate the offer request to said at least one business that offers the category of product stated in the offer request;
c) said at least one business using an electronic device to issue an offer to the consumer if the offer request meets certain criteria;
d) the consumer accepting the offer; and
e) the consumer redeeming the accepted offer.

46. The method in accordance with claim 45, wherein the offer request further states a time frame during which the consumer prefers to purchase said at least one business's products.

47. The method in accordance with claim 45, wherein the offer request further states a time at which the consumer prefers to purchase said at least one business's products.

48. The method in accordance with claim 45, wherein the offer comprises an advertisement of said at least one business's products.

49. The method in accordance with claim 45, wherein the offer comprises a special deal on said at least one business's products.

50. The method in accordance with claim 45, wherein the offer comprises a discount on said at least one business's products.

51. The method in accordance with claim 45, further comprising the consumer checking in at the business.

52. The method in accordance with claim 45, further comprising the consumer presenting an offer coupon to said at least one business upon redeeming the offer.

53. The method in accordance with claim 45, further comprising:
a) the consumer disputing the transaction if said at least one business refuses to honor terms of the offer;
b) the service provider charging said at least one business an amount due the customer under the terms of the offer if the customer wins the dispute; and
c) the service provider crediting the consumer the amount due the consumer under the terms of the offer if the consumer wins the dispute.

54. The method in accordance with claim 45, further comprising the consumer rating his experience with the business.

55. The method in accordance with claim 45, further comprising the service provider providing said at least one business with analytics regarding the consumer.

56. The method in accordance with claim 55, wherein the analytics comprise a frequency with which the consumer visits said at least one business.

57. The method in accordance with claim 55, wherein the analytics comprise a total amount that the consumer has spent at said at least one business.

58. The method in accordance with claim 55, wherein the analytics comprise an average amount that the consumer spends at said at least one business per transaction.

59. The method in accordance with claim 55, further comprising said at least one business using the analytics to determine whether the consumer is a regular.

60. The method in accordance with claim 59, further comprising said at least one business providing the consumer with special deals if the consumer is a regular.

61. A method of communicating for facilitating commercial activity between a first consumer and at least one other consumer, the method comprising:
a) the first consumer using an electronic device to communicate an offer request to said at least one other consumer, the offer request stating a dollar amount that the first consumer intends to spend on one or more products offered by said at least one other consumer; and
b) said at least one other consumer using an electronic device to communicate an offer to the consumer if the offer request meets certain criteria.

62. The method in accordance with claim 61, wherein the offer request further states a time frame during which the first consumer prefers to purchase said at least one other consumer's products.

63. The method in accordance with claim 61, wherein the offer request further states a time at which the first consumer prefers to purchase said at least one other consumer's products.

64. The method in accordance with claim 61, wherein the offer request further states a geographical area in which the first consumer prefers to purchase said at least one other consumer's products.

65. The method in accordance with claim 61, wherein the offer comprises an advertisement of said at least one other consumer's products.

66. The method in accordance with claim 61, wherein the offer comprises a special deal on said at least one other consumer's products.

67. The method in accordance with claim 61, wherein the offer comprises a discount on said at least one other consumer's products.

68. The method in accordance with claim 61, further comprising the first consumer accepting the offer.

69. The method in accordance with claim 68, further comprising the first consumer redeeming the accepted offer.

70. The method in accordance with claim 69, further comprising:
a) the first consumer disputing the transaction if said at least one other consumer refuses to honor terms of the offer; and
b) said at least one other consumer refunding an amount to the first consumer if the first consumer wins the dispute.

71. The method in accordance with claim 69, further comprising the first consumer rating his experience with said at least one other consumer.
